(19) United States
(12) Patent Application Publication
(10) Pub. No.: US 2025/0324089 A1
(43) Pub. Date: Oct. 16, 2025

(54) REPRODUCIBLE LEARNING-BASED POINT CLOUD CODING

(71) Applicant: InterDigital VC Holdings, Inc., Wilmington, DE (US)

(72) Inventors: Jiahao Pang, Plainsboro, NJ (US); Muhammad Asad Lodhi, Highland Park, NJ (US); Dong Tian, Boxborough, MA (US)

(21) Appl. No.: 18/637,370

(22) Filed: Apr. 16, 2024

(51) Int. Cl. H04N 19/597; H04N 19/124; H04N 19/184; H04N 19/46

(52) U.S. Cl. CPC H04N 19/597; H04N 19/124; H04N 19/184; H04N 19/46

(57) ABSTRACT

Some embodiments of a method may include: determining a first number by running a learning-based process, wherein the first number is associated with a current sample; obtaining a quantization parameter; determining a quantized value based on at least the quantization parameter for the first number; obtaining a sample set; responsive to determining that the current sample is not in the sample set, outputting the quantized value; and responsive to determining that the current sample is in the sample set, performing several steps comprising: determining a boundary value based on at least the quantization parameter and the first number; determining a second number based on the boundary value; and outputting the second number.

### INCORPORATION BY REFERENCE

The present application incorporates by reference in their entirety the following applications: International Patent Application Serial No. PCT/US2022/046950, entitled “HYBRID FRAMEWORK FOR POINT CLOUD COMPRESSION” and filed Oct. 18, 2022 (“950 application”); International Patent Application Serial No. PCT/US2022/052861, entitled “SCALABLE FRAMEWORK FOR POINT CLOUD COMPRESSION” and filed Dec. 14, 2022 (“861 application”); and International Patent Application Serial No. PCT/US2023/034393, entitled “SPARSE TENSOR-BASED BITWISE DEEP OCTREE CODING” and filed Oct. 30, 2023 (“393 application”), which claims priority to U.S. Provisional Patent Application Ser. No. 63/415,841 and filed Oct. 13, 2022 (“841 application”).

### BACKGROUND

The field of point cloud compression and processing aims to develop tools for compression, analysis, interpolation, representation and understanding of point cloud signals.

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

### SUMMARY

A first example method in accordance with some embodiments may include: determining a first number by running a learning-based process, wherein the first number is associated with a current sample; obtaining a quantization parameter; determining a quantized value based on at least the quantization parameter for the first number; obtaining a sample set; responsive to determining that the current sample is not in the sample set, outputting the quantized value; and responsive to determining that the current sample is in the sample set, performing several steps including: determining a boundary value based on at least the quantization parameter and the first number; determining a second number based on the boundary value; and outputting the second number.

For some embodiments of the first example method, the sample is one of a group consisting of: a point in point cloud, a pixel in an image, and a pixel in a video.

For some embodiments of the first example method, obtaining a sample set includes: accessing a safeguard bitstream; and decoding the safeguard bitstream.

For some embodiments of the first example method, obtaining a sample set includes: decoding the flag associated with the current sample.

Some embodiments of the first example method further include determining if the current sample is not in the sample set.

For some embodiments of the first example method, determining if the current sample is not in the sample set includes determining if a flag is cleared, the flag is associated with the current sample, and the flag indicates membership in the sample set.

For some embodiments of the first example method, determining the first number includes: passing at least one data point through an artificial intelligence (AI) model, wherein the learning-based process is the AI model.

For some embodiments of the first example method, determining the first number includes passing a bitstream through a synthesis block to generate the first number.

For some embodiments of the first example method, determining the first number further includes passing an output of the synthesis block through a bitstream matching process to generate the first number.

For some embodiments of the first example method, passing the output of the synthesis block through the bitstream matching process includes using a probability bitstream (PBS) generated by an encoder.

For some embodiments of the first example method, the method is performed within an encoding process.

A first example apparatus in accordance with some embodiments may include: a processor; and a memory storing instructions operative, when executed by the processor, to cause the apparatus to: determine a first number by running a learning-based process, wherein the first number is associated with a sample; obtain a quantization parameter; determine a quantized value based on at least the quantization parameter for the first number; obtain a sample set; responsive to determining that the current sample is not in the sample set, output the quantized value; and responsive to determining that the current sample is in the sample set, perform several steps including: determine a boundary value based on at least the quantization parameter and the first number; determine a second number based on the boundary value; and output the second number.

A second example method in accordance with some embodiments may include: determining a first number by running a learning-based process, wherein the first number is associated with a current sample; obtaining a quantization parameter and a threshold parameter; determining a quantized value based on at least the quantization parameter for the first number; determining a boundary value based on the quantization parameter and the first number; responsive to determining that the first number is not within the threshold parameter from the boundary value, outputting the quantized value; and responsive to determining that the first number is within the threshold parameter from the boundary value, performing several steps including: setting a flag for the current sample; encoding the flag into a safeguard bitstream; determining a second number based on the boundary value; and outputting the second number.

For some embodiments of the second example method, the sample is one of a group consisting of: a point in point cloud, a pixel in an image, and a pixel in a video.

For some embodiments of the second example method, performing the several steps further includes adding the current sample to a sample set.

For some embodiments of the second example method, determining the first number includes: passing at least one data point through an artificial intelligence (AI) model, wherein the learning-based process is the AI model.

For some embodiments of the second example method, determining the first number includes passing a bitstream through a synthesis block to generate the first number.

For some embodiments of the second example method, determining the first number further includes passing an output of the synthesis block through a bitstream matching process to generate the first number.

For some embodiments of the second example method, passing the output of the synthesis block through the bitstream matching process includes using a probability bitstream (PBS) generated by an encoder.

For some embodiments of the second example method, the method is performed within a decoding process.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 1C is a system diagram illustrating an example set of interfaces for a system according to some embodiments.

FIG. 2 is a flowchart illustrating an example encoding process according to some embodiments.

FIG. 3 is a flowchart illustrating an example decoding process according to some embodiments.

FIG. 4 is a schematic illustration showing an example matching of raw values with quantized values according to some embodiments.

FIG. 5 is a flowchart illustrating an example encoding process according to some embodiments.

FIG. 6 is a flowchart illustrating an example decoding process according to some embodiments.

FIG. 7 is a schematic illustration showing an example matching of raw values with quantized values according to some embodiments.

FIG. 8A is a process diagram illustrating an example deep octree encoding that may have mismatches according to some embodiments.

FIG. 8B is a process diagram illustrating an example deep octree decoding that may have mismatches according to some embodiments.

FIG. 9A is a process diagram illustrating an example deep octree encoding according to some embodiments.

FIG. 9B is a process diagram illustrating an example deep octree decoding according to some embodiments.

FIG. 10A is a process diagram illustrating an example hyperprior model encoding that may have mismatches according to some embodiments.

FIG. 10B is a process diagram illustrating an example hyperprior model decoding that may have mismatches according to some embodiments.

FIG. 11A is a process diagram illustrating an example hyperprior model encoding according to some embodiments.

FIG. 11B is a process diagram illustrating an example hyperprior model decoding according to some embodiments.

FIG. 12 is a flowchart illustrating an example decoding process according to some embodiments.

FIG. 13 is a flowchart illustrating an example coding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

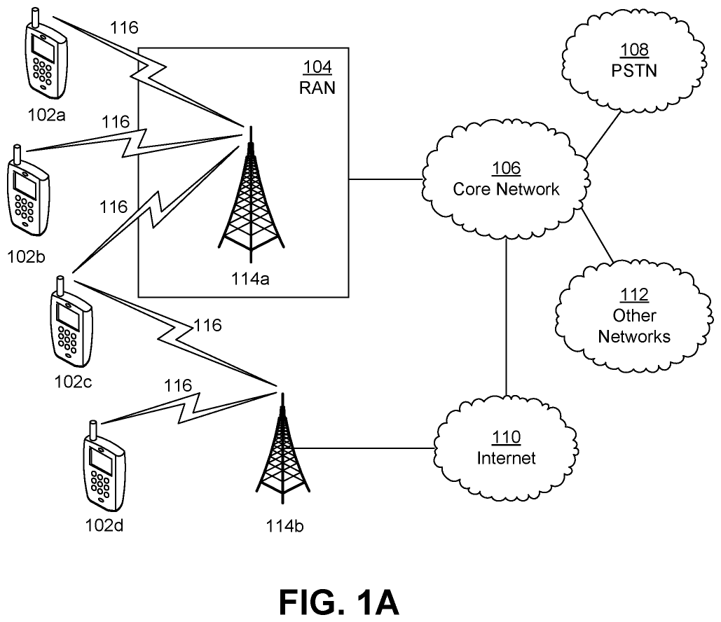

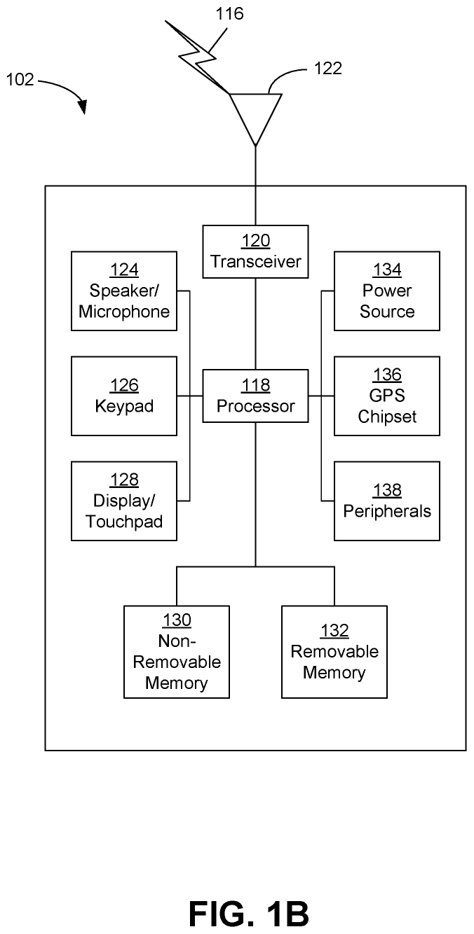

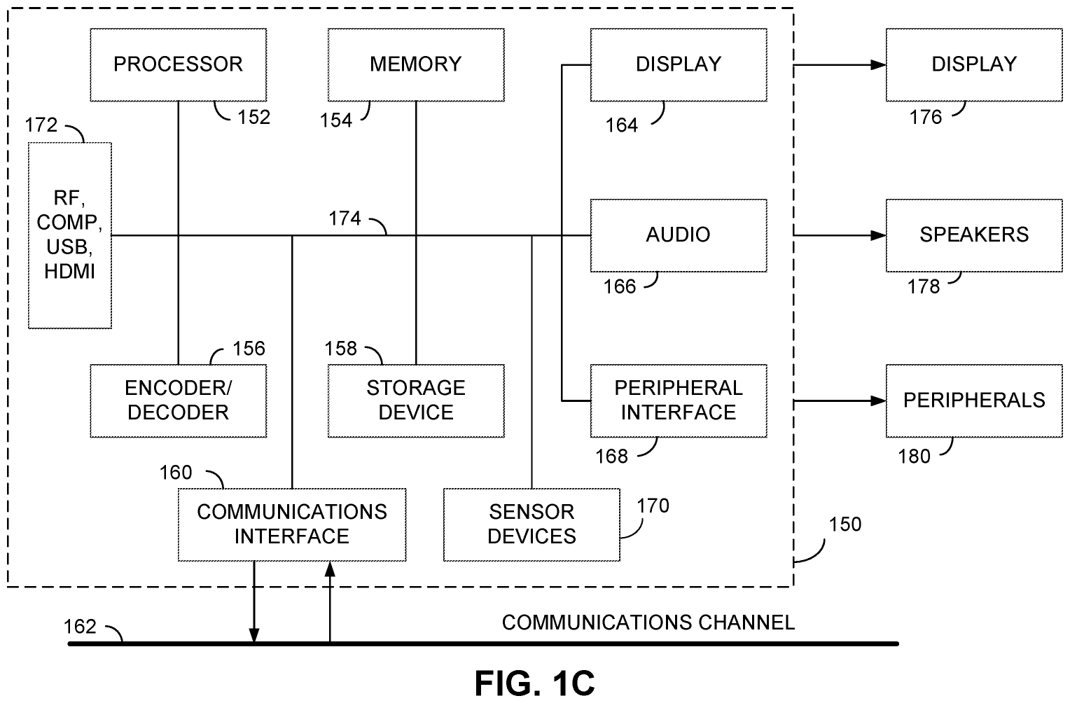

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1C is a system diagram illustrating an example set of interfaces for a system according to some embodiments. An extended reality display device, together with its control electronics, may be implemented for some embodiments. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 150 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 150 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Point Cloud Data Format

The field of point cloud compression and processing aims to develop tools for compression, analysis, interpolation, representation and understanding of point cloud signals.

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats are necessary for point cloud understanding and communication. In particular, raw point cloud data needs to be properly organized and processed for the purposes of world modeling & sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of a point cloud is represented by at least a 3D position (x, y, z). The point cloud captures the geometry of the object/scene, and the set of 3D positions illustrates the geometry of the object/scene. Additionally, each point of the point cloud may be associated with attributes, depending on the application. For example, for VR/AR/Gaming, such attributes may include color (r, g, b). For LiDAR, attributes may include reflectance (such as values and parameters).

### Point Cloud Data Use Cases

The automotive industry and autonomous car are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may help in making a decision.

Virtual Reality (VR) and immersive worlds have become a hot topic and are foreseen by many as the future of 2D flat video. The viewer is immersed in an environment all around the viewer as opposed to standard TV where the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects like statues or buildings are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data include discrete samples of the surfaces of objects or scenes. A huge number of points may be used to fully represent the real world with point samples. For instance, a typical VR immersive scene contains millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for any processing or inference on the point cloud is to have efficient storage methodologies. To store and process the input point cloud with affordable computational cost, the point cloud may be down-sampled first, where the down-sampled point cloud summarizes the geometry of the input point cloud while having much fewer points. The down-sampled point cloud may be fed to a machine task for further consumption. However, further reduction in storage space may be achieved by converting the raw point cloud data (original or down sampled) into a bitstream through entropy coding techniques for lossless compression.

In addition to lossless coding, many scenarios for lossy coding seek significantly improved compression ratios while maintaining the induced distortion under certain quality levels. To achieve a less lossy coding, an efficient point feature extractor may improve the accuracy of the reconstruction within the given resource budget.

### Learning-Based Point Cloud Compression

Since point cloud data is composed of two components (geometry information and attribute information), the compression of point clouds may be classified into two categories: geometry coding and attribute coding.

Examples of learning-based point cloud geometry compression techniques include deep octree coding and end-to-end feature-based geometry coding. With deep octree coding, neural network-based models are utilized to estimate the occupancy probabilities. Such estimated probabilities are used to help the arithmetic coder to encode or decode a binary flag that indicates whether a child octree voxel is occupied or empty.

Inference reproducibility is a well-known problem: neural network models may produce results with minor differences when they run on different hardware or software platforms, or when they run multiple times. One of the reasons behind this phenomena is due to the implementation of some functions used to build a neural network model, e.g., convolutional neural networks (CNNs) and multi-perception layers (MLPs). When neural network models are used for entropy encoding and decoding, a slightly different output may be a severe problem for the entropy encoder and decoder. Not only will a different point cloud be outputted, but a decoding process may crash. Although this application discusses a learning-based point cloud compression, the principals may be applied to learning-based image/video compression.

Some technologies exist to provide relief to the reproducibility challenge of a neural network. Two related technologies are briefly described in this section. However, unless the hardware and software platform are strictly aligned, these techniques, as understood, cannot fully achieve the reproducibility.

### Quantization

According to Gholami, A., et al., A Survey of Quantization Methods for Efficient Neural Network Inference. LOW-POWER COMPUTER VISION 291-326 (2022) (“Gholami”), quantization reduces the computational and memory costs of running inference by representing numerical values (weights and activations) using low-precision data types (e.g., 8-bit integers) instead of traditional 32-bit floating-point data types.

By using fixed-point representations, quantization also promotes more consistent behavior across different hardware and software environments. Quantization mitigates the impact of floating-point rounding errors, which leads to more predictable results during inference. Quantized models are lightweight and suitable for deployment on resource-constrained devices, like mobile phones and edge devices. However, quantized models still cannot fully guarantee reproducibility-which may be critical for learning-based compression.

### Activation Functions

Deep learning models need to use activation functions like Rectified Linear Units (ReLU). Rasamoelina, Andrinandrasana David, et al., A Review of Activation Function for Artificial Neural Network, 2020 IEEE 18TH WORLD SYMPOSIUM ON APPLIED MACHINE INTELLIGENCE AND INFORMATICS (SAMI) 281-286 (2020) (“Rasamoelina”). ReLU exacerbates irreproducibility due to its non-smooth derivative behavior.

Smooth activation functions have continuous derivatives across their entire domain, unlike ReLU. Examples include Sigmoid, Tanh, and Swish. Smooth ReLU (SmeLU) activation function may balance reproducibility and accuracy without the complexity of other solutions. There is no guarantee that activation brings fully reproducible results but may mitigate the issue. However, for learning-based compression, reproducibility may be indispensable.

This application discusses a method that may be used to achieve inference reproducibility in learning-based point cloud compression. The same method may be applied to learning-based image/video compression.

This application discusses a way to ensure reproducibility compatibility when learning-based methods are used in compression across different platforms. A safeguard bitstream may be generated by an encoder. A decoder may use the safeguard bitstream to reconstruct exactly the same values as in the encoder. An example is shown of how this method may be used for deep octree coding for point cloud coding. Another example is shown for a hyperprior model that may be applied for both learning-based point cloud coding and image/video coding.

An overview of the method is presented and then a description is given for how the approach is used for deep octree coding in point cloud compression and how the approach is used for a hyperprior model in point cloud compression (and image/video compression).

### Reproducibility Compatibility

An AI-based block (or module) M may be used to compute a scalar variable per sample. For some embodiments, the AI-based block (or module) M may be part of larger AI-based model. The sample may be a point in a point cloud compression or a pixel in an image/video compression. The scalar variable may be the probability that a child octree voxel is occupied in deep octree coding. For a hyperprior model, the variable may be Gaussian distribution parameters, e.g., mean and variance numbers.

Let vₓ be the variable, in which x is the sample. Typically, vₓ is a floating-point number as determined (or computed for some embodiments) by the AI-based model. Although some AI-based blocks may use integers as neural network weights, the output may still not be reproducible. Without losing generality, the variable vₓ is assumed to be a floating-point number, which suffers a reproducibility problem across different platforms.

Regarding decoding reproducibility, a reproducibility compatible AI-based decoding method is able to decode a bitstream on different platforms with the quality of the decoded point cloud (or image/video) being either exactly the same or within a specific mismatch error when run over different platforms.

Regarding encoding/decoding reproducibility, a reproducibility compatible AI-based decoding method is able to decode a bitstream on a platform and reconstruct exactly the same point cloud (or image/video) or within a specific mismatch error when compared to the point cloud reconstructed during encoding that was performed on a different platform.

A maximum error in the variable vₓ among different targeted platforms is assumed to exist. Given an AI-based model [symbol] , a maximum error (max_err) between the targeted platforms may be evaluated, e.g., between different hardware platforms, like GPUs. For each such particular AI-based model [symbol] , a table of maximum errors between any two GPU models is provided for reference. This table is labeled as table [symbol] in this application. A way to obtain such a table is described below.

Given a (fixed) AI-based block (or, e.g., module), the model [symbol] may be run on all the GPU hardware platforms for which there is an interest, and individual outputs may be collected. If there are N GPUs for a test input, then there are N different outputs from [symbol] , denoted as V₁, V₂, . . . , V₃, where each Vᵢ is a tensor or an array output of [symbol] . The test input (test point cloud or test image) is selected carefully to ensure enough representability. To measure the maximum error between two GPUs, say GPU i and j, the difference Dᵢⱼ between Vᵢ and Vⱼ, is computed (Dᵢⱼ=Vᵢ−V_{j,}). The maximum absolute value among the elements in Dᵢⱼ is computed. This value is the maximum error between GPU i and j, which is denoted as max_errᵢⱼ. By computing all the max_errᵢⱼ for different GPU pairs i and j, the table GPU_MAX_ERR [symbol] is obtained. To avoid potential coverage issues due to limited test inputs, the maximum GPU error values may be increased by a marginal percentage or amount.

Additionally, a perfect determining the max_errᵢⱼ may be the best option in practice if all errors want to be avoided. However, in some cases where certain error rate may be tolerable, then max_errᵢⱼ may be replaced by a threshold value. If larger threshold value is in use, the encoder is sending a larger safeguard bitstream to ensure a lower error rate. Otherwise, a smaller threshold value is in use, the encoder is sending a lighter safeguard bitstream but resulting a higher error rate.

A maximum tolerable error ϵ may be signaled to the decoder using a high-level syntax element in a sequence parameter set, a picture parameter set, or a supplemental enhancement information message (SEI). This maximum tolerable error ϵ is accompanied by a second syntax element (ref_gpu), which indicates on which GPU model the bitstream was encoded. In table GPU_MAX_ERR_{M}, the decoder may access the maximum error (max_err) between the GPU model used for decoding and the GPU model used in encoding. If the maximum error (max_err) is found to be small or equal to E, the decoding is guaranteed to be properly performed.

Consider the idea of applying a quantization on the variable vₓ. Performing only quantization will not guarantee achieving the reproducibility, no matter how small the maximum error (max_err) is. In fact, when the variable vₓ falls within a vicinity of quantization boundaries, the quantized value may become different across different GPUs. The quantization function on the variable vₓ may be a function related to the quantization step QS as shown in Eq. 1:

$$Q ( {v}_{x} ) = int ( \frac{{v}_{x}}{QS} + 0.5 ) \qquad ( 1 )$$

where the int(·) function may be a flooring function to the closest integer number not larger than a given number. In the descriptions of the configurations below, a uniform quantization function is assumed, while advanced quantization functions may be applied in a similar way.

Additional parameters may be used with quantization. For example, offset and scaling parameters may be used. When an offset is introduced, the quantization function becomes Eq. 2:

$$Q ( {v}_{x} ) = int ( \frac{{v}_{x} + OFFSET}{QS} + 0.5 ) \qquad ( 2 )$$

When scaling is further introduced, the quantization function becomes Eq. 3:

$$Q ( {v}_{x} ) = int ( \frac{( SCALING \cdot {v}_{x} ) + OFFSET}{QS} + 0.5 ) \qquad ( 3 )$$

### Configuration 1

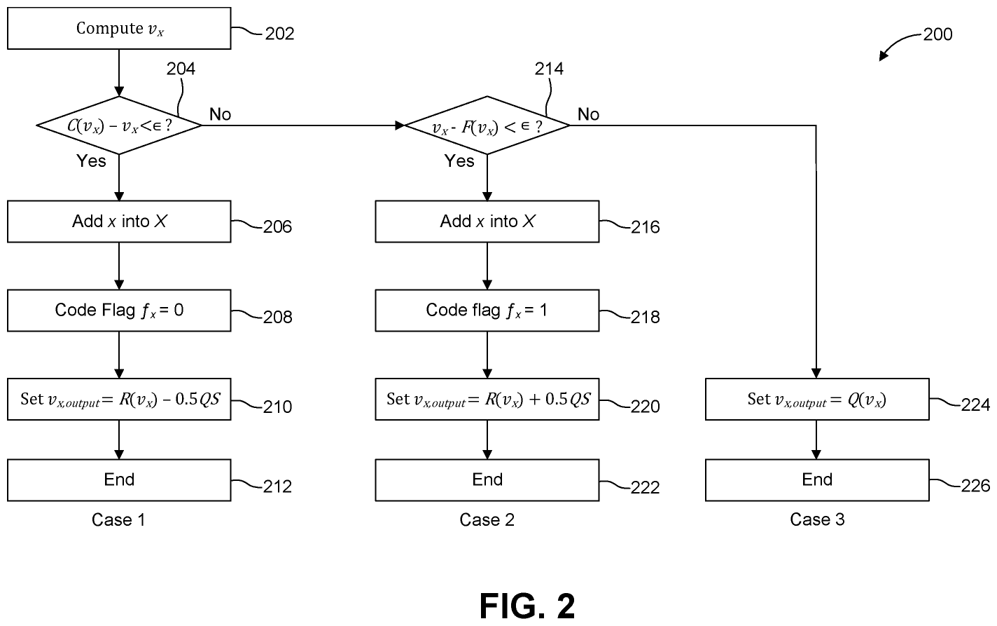

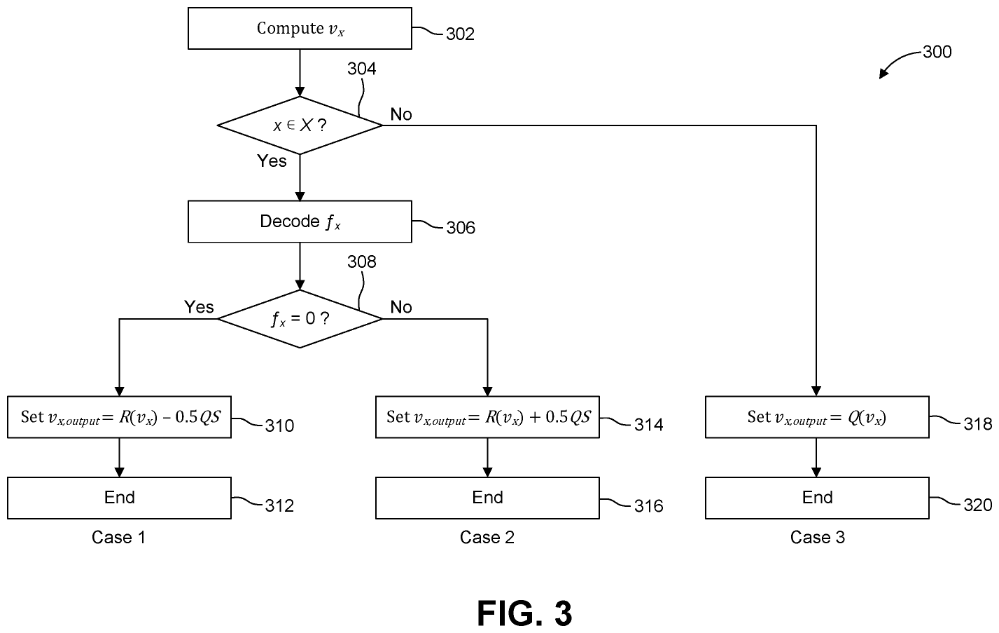

A first configuration of encoding and decoding is shown in FIGS. 2 and 3.

### Encoding

FIG. 2 is a flowchart illustrating an example encoding process according to some embodiments. As shown in the process 200 of FIG. 2, for a current point x, the encoding starts with computing 202 the variable vₓ by running the AI model [symbol] on the encoder's GPU. Two conditions 204, 214 are checked against the ceiling and flooring values respectively. For illustration, the ceiling function C(vₓ) computes the upper quantization boundary associated with vₓ. In contrast, the flooring function F(vₓ) computes the lower quantization boundary.

If the ceiling C(vₓ) minus vₓ is less than a threshold Σ, the current point x (or pixel in image/video) is added 206 into a “risky” set X that needs extra care to ensure reproducibility. See case 1 in FIG. 2. The threshold E is also the maximum tolerable error for decoding. The risky set X is coded into the bitstream. For some embodiments, the risky set X encoded directly is a list of points. That is, the 3D position of each point in X is coded. For some embodiments, a flag is associated with all points. The flag indicates if a point belongs to set X or not. For example, a coded flag may be used. For this example, a true condition for the coded flag means that the corresponding point x belongs to X. Moreover, a flag fₓ=0 may be coded 208 in a bitstream to indicate that the quantized value of the variable vₓ should be on the left side of its rounded value. For vₓ, the encoding sets 210 an output value according to Eq. 4:

$${v}_{x , output} = R ( {v}_{x} ) - 0.5 QS \qquad ( 4 )$$

The subtraction of 0.5QS shifts the value to the left by half of the quantization step. R(vₓ) is a rounding function, which rounds vₓ to the closest quantization boundary value. Case 1 then exits 212.

If vₓ minus the flooring F(vₓ) is less than a threshold Σ, x is added 216 into set X. See case 2 in FIG. 2. The flag fₓ=1 is coded 218 into bitstream in this case. The output value is set 220 according to Eq.5:

$${v}_{x , output} = R ( {v}_{x} ) + 0.5 QS \qquad ( 5 )$$

The addition of 0.5QS shifts the value to the right by half of the quantization step. Case 2 then exits 222.

If vₓ is not close (not within a threshold ϵ) to either ceiling or flooring values, the quantization will be “safe” and may be reproduced on the decoder. See case 3 in FIG. 2. The output is set 224 according to Eq. 6:

$${v}_{x , output} = Q ( {v}_{x} ) \qquad ( 6 )$$

Case 3 then exits 226.

### Decoding

FIG. 3 is a flowchart illustrating an example decoding process according to some embodiments. As shown in the process 300 of FIG. 3, for a current point x, the decoding starts with computing 302 the variable vₓ by running the AI model [symbol] on the decoder's GPU. The value of vₓ may have a minor difference compared to the value computed at the encoder on a different GPU. The decoder checks 304 if x belongs to the risky set X. If not, the variable vₓ's value is assumed to be in a “safe” range, and a quantization is done. See case 3 in FIG. 3. The output value is set 318 according to Eq. 7:

$${v}_{x , output} = Q ( {v}_{x} ) \qquad ( 7 )$$

Case 3 then exits 320.

However, if x belongs to the set X, there are chances for vₓ to be either larger than or smaller than its rounded value R(vₓ) (which is the closest quantization boundary) while x is within a maximum error range. A mismatch in quantization will happen if the encoding and decoding fall on different sides of the rounded value. For some embodiments, the flag fₓ is used to control the mismatch.

If fₓ=0 is decoded, the output of vₓ is set 310 to v_{x,output}=R (vₓ)−0.5QS. See case 1 in FIG. 3. That is, the encoder tells the decoder that the encoded value falls on the left side of the rounded value. So, the decoder needs to do the same thing. This is implemented using R(vₓ)−0.5QS than Q(vₓ) because the quantization function Q(vₓ) may output a value to the right side of the rounded value. Case 1 then exits 312. If fₓ=1 is decoded, the output of vₓ is set 314 to v_{x,output}=R(vₓ)+0.5QS. See case 2 in FIG. 3. In this case, the encoder tells the decoder that the encoded value falls on the right side of the rounded value. Case 2 then exits 316.

Comparing FIG. 2 with FIG. 3, the process 300 shown in FIG. 3 intends to send a more accurate value from an encoding point of view. However, the process 300 in FIG. 3 uses an extra flag for each element in X to be signaled in the bitstream.

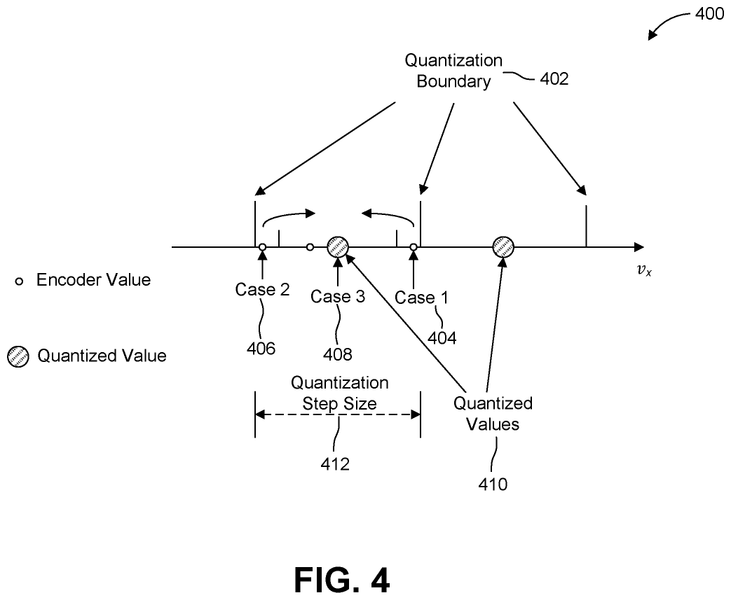

FIG. 4 is a schematic illustration showing an example matching of raw values with quantized values according to some embodiments. The process 400 shows the cases 1, 2, and 3 (404, 406, 408) that correspond to cases 1, 2, and 3 of FIGS. 2 and 3. FIG. 4 shows several quantization boundaries 402 with quantized values 410 located at the halfway point between each respective set of quantization boundaries 402. Each quantization boundary 402 is separated by a quantization step size 412. Case 1 (404) is the scenario where the encoder value is shifted to the left of the quantization value 410. Case 2 (406) is the scenario where the encoder value is shifted to the right of the quantization value 410. Case 3 (408) is the scenario where the encoder value is set to the quantization value 410.

### Configuration 2

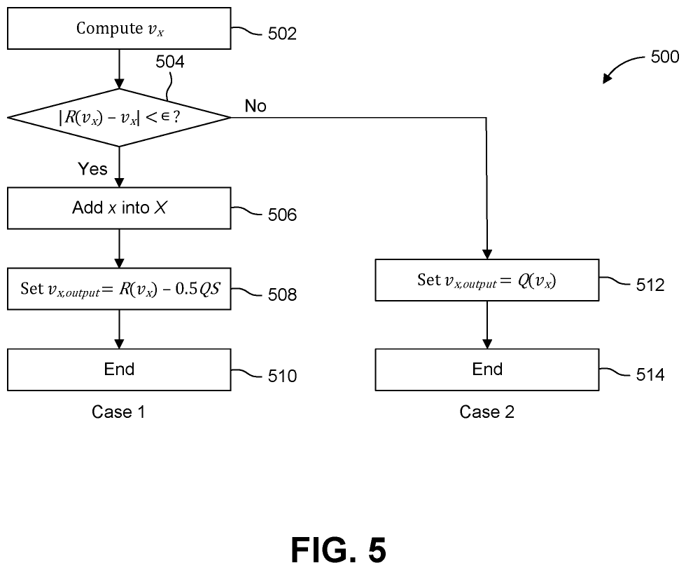

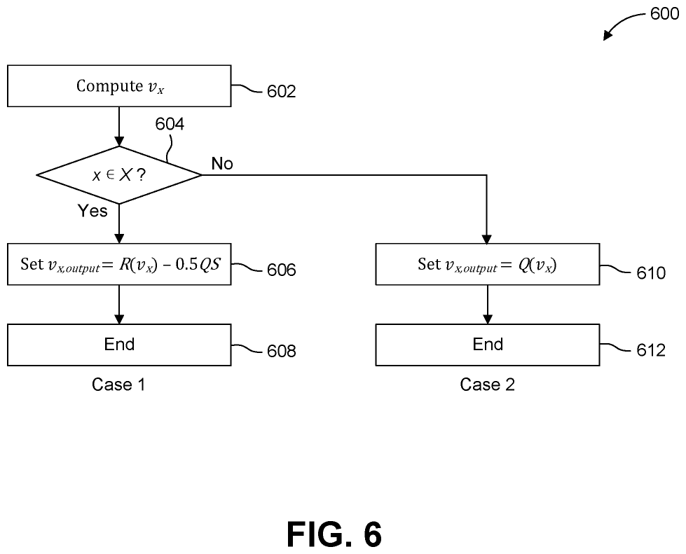

In the second configuration, the coding of the flag fₓ in the bitstream is skipped. The modified encoding and decoding procedures are shown in FIGS. 5 and 6.

FIG. 5 is a flowchart illustrating an example encoding process according to some embodiments. For the encoder process 500 of FIG. 5, the variable vₓ is computed 502. The absolute distance of the variable vₓ from its rounded position R(vₓ) is checked 504. If the error is larger than a certain threshold ϵ, the variable is assumed to be in a “safe” range. The output is set to 512 its quantized value v_{x,output}=Q(vₓ) and case 2 ends 514.

Otherwise, the current point x is added 506 to set X (which is signaled to the decoder), and the variable vₓ is set 508 according to Eq. 8:

$${v}_{x , output} = R ( {v}_{x} ) - 0.5 QS \qquad ( 8 )$$

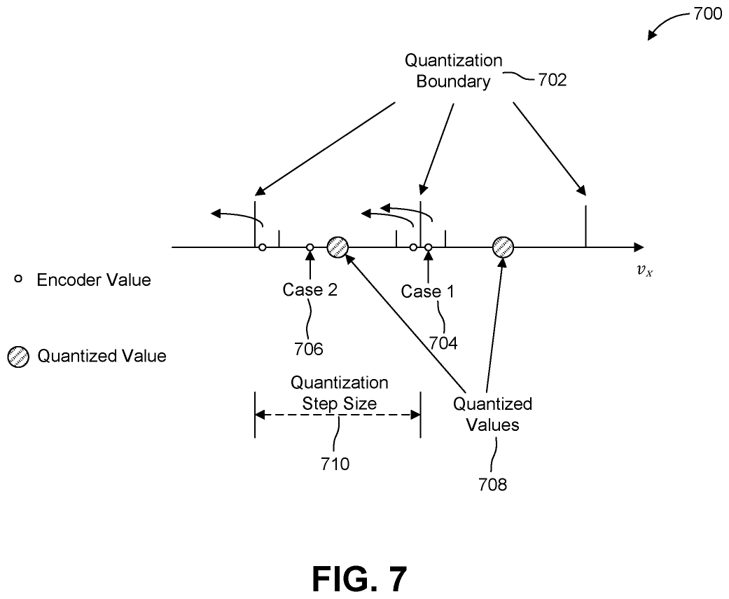

In other words, the variable vₓ is shifted to the left of the rounded value by half of the quantization step. See FIG. 7 for an illustration. Then, case 1 ends 510.

FIG. 6 is a flowchart illustrating an example decoding process according to some embodiments. For the decoder process 600 of FIG. 6, the variable vₓ is computed 602 and a determination 604 is made on whether a current point x does not belongs to the set X. If the current point x does not belong to the set X, the output is set 610 to its quantized value v_{x, output}=Q (vₓ) and then case 2 ends 612. Otherwise, the output is set 606 to v_{x,output}=R(vₓ)−0.5QS and case 1 ends 608.

FIG. 7 is a schematic illustration showing an example matching of raw values with quantized values according to some embodiments. The process 700 shows the cases 1 and 2 (704, 706) that correspond to cases 1 and 2 of FIGS. 5 and 6. FIG. 7 shows several quantization boundaries 702 with quantized values 708 located at the halfway point between each respective set of quantization boundaries 702. Each quantization boundary 702 is separated by a quantization step size 710. Case 1 (704) is the scenario where the encoder value is shifted to the left. Case 2 (706) is the scenario where the encoder value is set to the quantization value 708.

The “left-preferred method” shown in FIG. 7 may appear less accurate because some values on the right side of the rounded value are quantized to a value not closest to the variable. However, the process 700 avoids signaling a flag fₓ, which is used in configuration 1.

### Configuration 3

Similar to the “left-preferred method” in Configuration 2, a “right-preferred” quantization may be performed (not shown). If the encoder detects that the current point is in the “risky” range, the output is set to

$${v}_{x , output} = R ( {v}_{x} ) + 0.5 .$$

### DISCUSSION

In some embodiments, one needs to ensure that the quantization step QS is at least twice of the threshold ϵ. Otherwise, the methods may not work. Additionally, the threshold ϵ needs to be selected larger or equal to the maximum error max_err for a current AI model [symbol] .

The bitstream generated following/according to the configurations described above is to safeguard the reproducibility compatibility. This protection may be an overhead for some embodiments.

The overhead is called a safeguard bitstream in some portions of this application. The amount of overhead may be determined by the quantization step and the threshold ϵ. A larger quantization step may have a smaller overhead but may degrade more the coding efficiency. A smaller threshold ϵ may have a smaller overhead but may reduce the decoder reproducibility.

Since a smaller threshold (ϵ) may reduce the overhead, technologies such as quantizing neural network weights may decrease the potential maximum error max_err so that a smaller e may be used without risks. For different target GPUs, the safeguard bitstream may be generated respectively. If possible, use of the same or similar GPU to encode (and decode) may reduce the size of the safeguard bitstream when a target GPU is known.

### Use Cases

For some embodiments, AI models may benefit from reproducibility compatibility, such as deep octree coding and hyper-prior model.

### Deep Octree Coding

The coding of a point cloud may be done via the coding of its octree decomposition structure. In this use case, the empty/occupancy flag is coded for each child voxel in the octree structure.

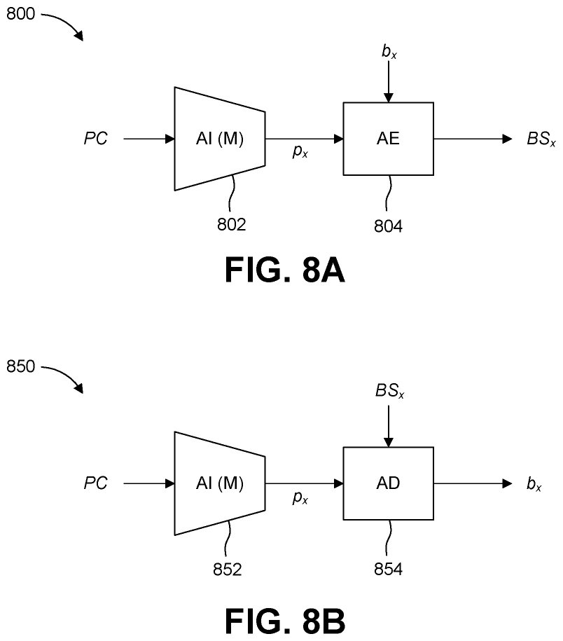

FIG. 8A is a process diagram illustrating an example deep octree encoding that may have mismatches according to some embodiments. FIG. 8B is a process diagram illustrating an example deep octree decoding that may have mismatches according to some embodiments.

As shown in FIGS. 8A-8B, with a deep octree coding scenario, an AI model M is used to predict the probability pₓ that a child voxel is occupied. This model M is typically run as part of an encoder process 800 and a decoder process 850. A “general” AI model 802, 852 is used for compression. The probability is used to guide the entropy coding/decoding via “AE” 804 in FIG. 8A and “AD” 854 in FIG. 8B. In this case, any mismatch in the probability value pₓ between the encoder and the decoder may lead to a completely wrong decoding of an octree voxel. This situation is a serious error and may result in very poor point cloud reconstruction quality.

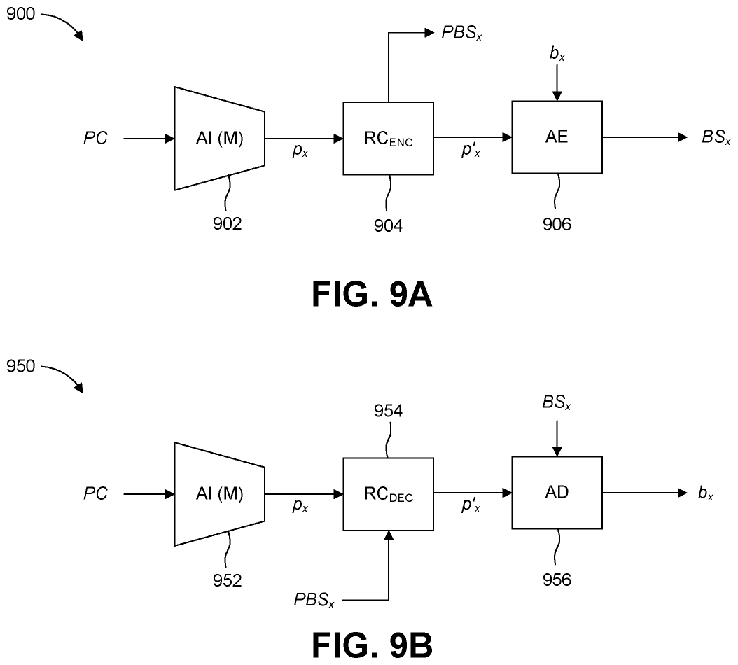

FIG. 9A is a process diagram illustrating an example deep octree encoding according to some embodiments. FIG. 9B is a process diagram illustrating an example deep octree decoding according to some embodiments.

The configurations 1 to 3 described above may be used with deep octree coding. The probability pₓ is treated as vₓ described in relation to FIGS. 2-7. This treatment leads to the modified encoding process 900 in FIG. 9A and modified decoding process 950 shown in FIG. 9B. A “general” AI model 902, 952 is used for compression. The probability is used to guide the entropy coding/decoding via arithmetic encoding (“AE”) 906 in FIG. 9A and arithmetic decoding (“AD”) 956 in FIG. 9B.

The “RC_{ENC}” block 904 and “RC_{DEC}” block 954 are introduced in the encoder and the decoder, which may follow one of the three configurations described above. For some embodiments, the updated probability p′ₓ is exactly matched between encoder and decoder. The safeguard bitstream newly generated is labeled as PBSₓ (probability bitstream) for each point.

### Configuration 4 (for Deep Octree Coding)

Besides the three configurations discussed above, for deep octree coding, once a point x is identified as “risky” and added to the “risky” set X, the encoder may directly output p_{x,output}=R(vₓ), which is the value of the closest quantization boundary. Hence, R(vₓ) is a rounded value. In this configuration 4, the only overhead is the “risky” set X. No extra flag is used, which is similar to configurations 2 and 3 mentioned above.

On the decoder side, having decoded the set X and recognized x as a risky point, the decoder may directly output p_{x,output}=R(vₓ), so that the decoder is aligned with the output on the encoder side. By using configuration 4, there is no preference to the left or to the right like configurations 2 and 3 discussed earlier. Hence, the probability value may be better preserved, which may benefit compression performance.

### Hyperprior Model

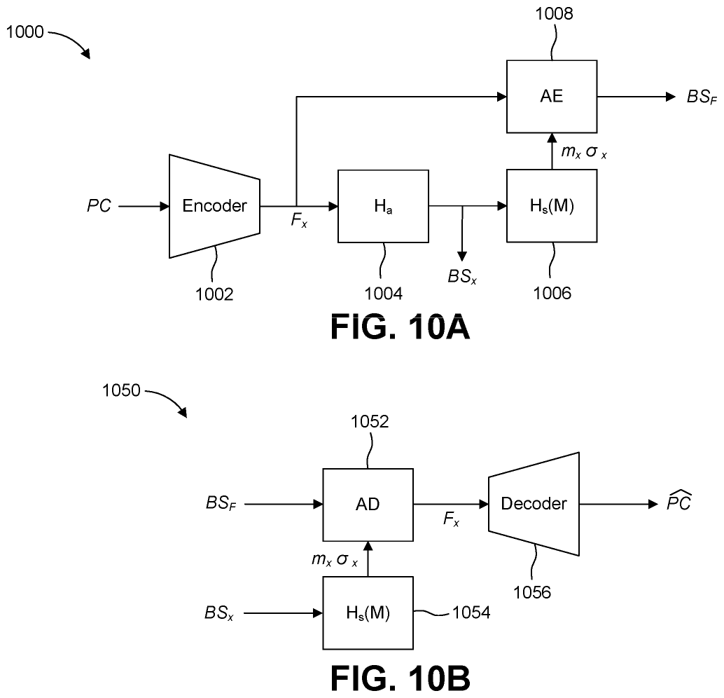

FIG. 10A is a process diagram illustrating an example hyperprior model encoding that may have mismatches according to some embodiments. FIG. 10B is a process diagram illustrating an example hyperprior model decoding that may have mismatches according to some embodiments.

A hyperprior model may be used to assist the coding of features in learning-based compression of image/video/point clouds. FIGS. 10A-10B show how a hyperprior model may work in an encoder process 1000 and a decoder process 1050, respectively.

On encoder side, an input point cloud (or image, video) goes through an “encoder” block 1002 and generates a feature map Fₓ to be coded. The “AE” block 1008 is an arithmetic encoder, that takes distribution parameters as inputs. In a typical design, the distribution parameters may be Gaussian parameters, such as mean value mₓ and variance σₓ. The so-called hyperprior model has two parts on an encoder: an analysis block Hₐ 1004 and a synthesis block Hₛ 1006. Both parts may be implemented via some neural network layers. The output of the analysis block 1004, BSₓ, is sent to decoder. The outputs of the synthesis block 1006 are Gaussian parameters. The Gaussian parameters are used to instruct the arithmetic encoder “AE” 1008 to generate the feature map bitstream, BS_{F}.

On decoder side, the input bitstream, BSₓ, goes through the synthesis block Hₛ 1054 to generate the Gaussian parameters. The feature map bitstream, BS_{F} is received as an input and is passed through an arithmetic decoder (“AD”) 1052 to generate a feature map Fₓ to be decoded by the decoder 1056. The output of the decoder 1056 is the decoded version of the point cloud, [symbol] .

For some embodiments, the output of the analysis block Hₐ 1004 may be assumed to be exactly reproduced on the decoder side because only non-learning-based arithmetic decoding methods will be used on the decoder side to decode the output of the analysis block Hₐ 1004.

Because the synthesis block 1006, 1054 is learning-based and is run on both the encoder and the decoder, the respective outputs (Gaussian parameters) may have mismatches and may cause serious decoding problems.

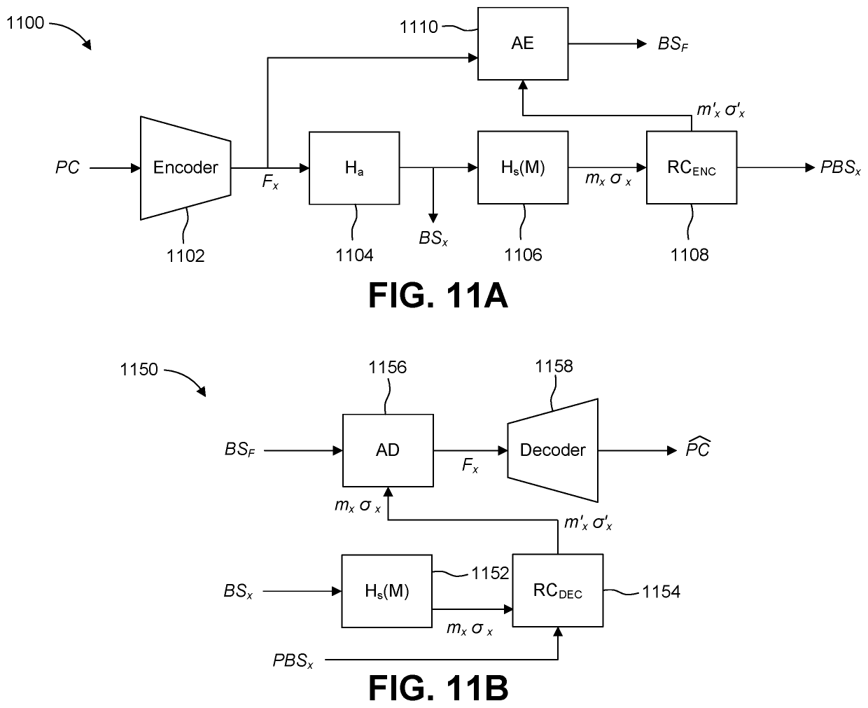

FIG. 11A is a process diagram illustrating an example hyperprior model encoding according to some embodiments. FIG. 11B is a process diagram illustrating an example hyperprior model decoding according to some embodiments.

Hence, the ideas in configurations 1-3 and in the discussion of FIGS. 9A-9B may be used. The synthesis block Hₛ 1106, 1152 may be treated as the AI module M discussed with regard to FIGS. 8A, 8B, 9A, and 9B. The variable vₓ may be used for the mean value mₓ and variance σₓ.

The modified encoding process 1100 and the modified decoding process 1150 with each using a hyperprior model are shown in FIGS. 11A-11B. The “RC_{ENC}” block 1108 and “RC_{DEC}” block 1154 are introduced in the encoder process 1100 and the decoder process 1150, which follows one of the three configurations described above. The updated mean value m′ₓ and variance σ′ₓ are matched between encoder and decoder. The newly generated safeguard bitstream is labeled as PBS, for each point in point cloud coding (or pixel in image/video coding).

On encoder side, an input point cloud (or image, video) goes through an “encoder” block 1102 and generates a feature map Fₓ to be coded. The “AE” block 1110 is an arithmetic encoder, that takes distribution parameters as inputs. The so-called hyperprior model has two parts on an encoder: an analysis block Hₐ 1104 and a synthesis block Hₛ 1106. Both parts may be implemented via some neural network layers. The output of the analysis block 1104, BSₓ, is sent to decoder. The outputs of the synthesis block 1106 are Gaussian parameters. The Gaussian parameters are used to instruct the arithmetic encoder “AE” 1110 to generate the feature map bitstream, BS_{F}.

On decoder side, the input bitstream, BSₓ, goes through the synthesis block Hₛ 1152 to generate the Gaussian parameters. The feature map bitstream, BS_{F} is received as an input and is passed through an arithmetic decoder (“AD”) 1156 to generate a feature map Fₓ to be decoded by the decoder 1158. The output of the decoder 1158 is the decoded version of the point cloud, [symbol] .

### Configuration 5 (for Hyperprior Model)

During inference, the hyperprior model quantizes the mean value mₓ and variance σₓ (which are outputted by Hₛ) inside the arithmetic encoder AE (and the arithmetic decoder AD). Rather than perform uniform quantization as discussed above, the arithmetic encoder AE performs non-uniform quantization, and the quantization boundaries are learned during the training stage.

For some embodiments, the learned quantization boundaries may be used directly for the RC_{ENC} block to generate m′ₓ, variance σ′ₓ, and the bitstream PBSₓ. On the decoder side, the learned quantization boundaries may be used directly for the RC_{DEC} block 1154 to generate m′ₓ and variance σ′ₓ according to the bitstream PBSₓ. The rest of the details remain the same as the three configurations described above.

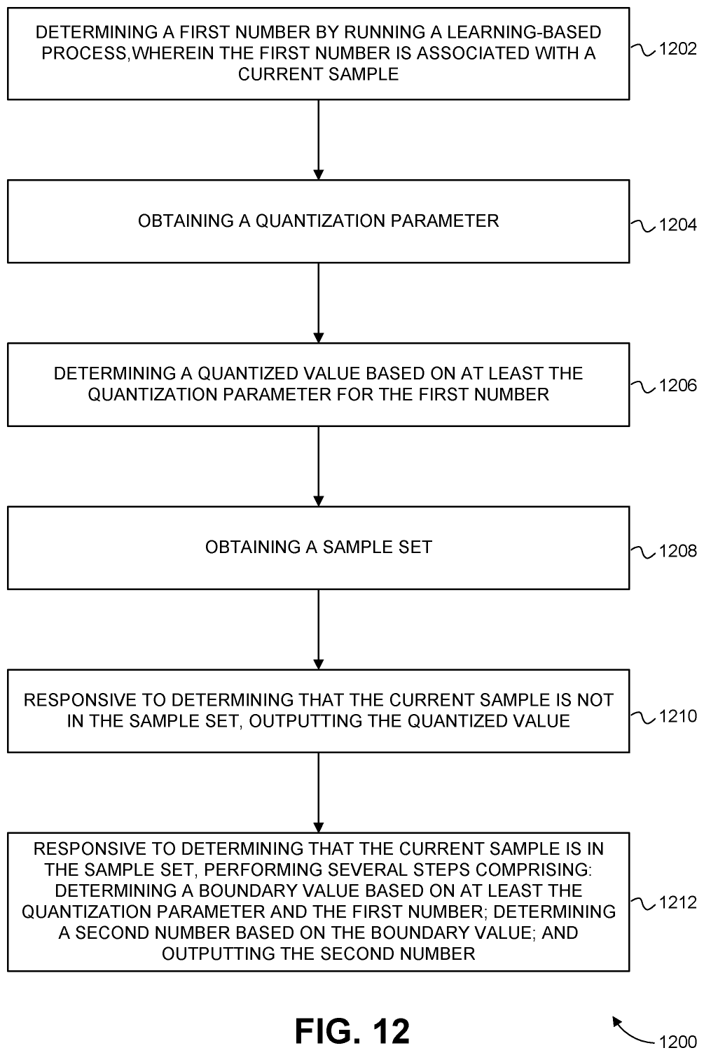

FIG. 12 is a flowchart illustrating an example decoding process according to some embodiments. For some embodiments, an example process 1200 may include determining 1202 a first number by running a learning-based process, wherein the first number is associated with a current sample. For some embodiments, the example process 1200 may further include obtaining 1204 a quantization parameter. For some embodiments, the example process 1200 may further include determining 1206 a quantized value based on at least the quantization parameter for the first number. For some embodiments, the example process 1200 may further include obtaining 1208 a sample set. For some embodiments, the example process 1200 may further include responsive to determining that the current sample is not in the sample set, outputting 1210 the quantized value. For some embodiments, the example process 1200 may further include responsive to determining that the current sample is in the sample set, performing 1212 several steps including: determining a boundary value based on at least the quantization parameter and the first number; determining a second number based on the boundary value; and outputting the second number.

For some embodiments, the process 1200 may be done within an encoder. For some embodiments, the process 1200 may be done within a decoder.

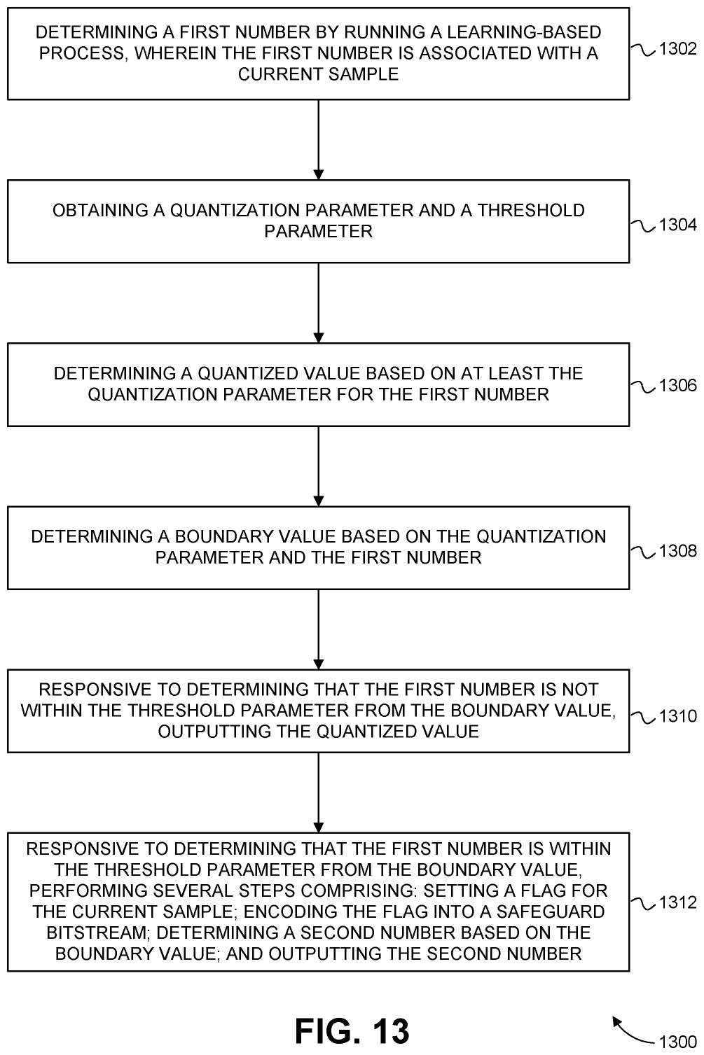

FIG. 13 is a flowchart illustrating an example coding process according to some embodiments. For some embodiments, an example process 1300 may include determining 1302 a first number by running a learning-based process, wherein the first number is associated with a current sample. For some embodiments, the example process 1300 may further include obtaining 1304 a quantization parameter and a threshold parameter. For some embodiments, the example process 1300 may further include determining 1306 a quantized value based on at least the quantization parameter for the first number. For some embodiments, the example process 1300 may further include determining 1308 a boundary value based on the quantization parameter and the first number. For some embodiments, the example process 1300 may further include responsive to determining that the first number is not within the threshold parameter from the boundary value, outputting 1310 the quantized value. For some embodiments, the example process 1300 may further include responsive to determining that the first number is within the threshold parameter from the boundary value, performing 1312 several steps including: setting a flag for the current sample; encoding the flag into a safeguard bitstream; determining a second number based on the boundary value; and outputting the second number.

For some embodiments, the process 1300 may be done within an encoder. For some embodiments, the process 1300 may be done within a decoder.

A first example method in accordance with some embodiments may include: determining a first number by running a learning-based process, wherein the first number corresponds to a current sample associated with a point cloud or an image/video; obtaining a quantization parameter and a threshold parameter; obtaining a safeguard bitstream; determining a rounded value of the first number, wherein the rounded value is a quantized value of the first number based on the quantization parameter; obtaining a sample set, wherein the sample set indicates if the current sample is safeguarded; and outputting a number based on the rounded value if the current sample is safeguarded, wherein the threshold parameter is used as part of determining if the current sample is safeguarded.

For some embodiments of the first example method, wherein determining the rounded value of the first number includes determining a boundary of a neighboring quantization range, and wherein the boundary of the neighboring quantization range is the rounded value of the first number.

Some embodiments of the first example method may further include outputting a quantized value if the sample set indicates that the current sample is not safeguarded.

Some embodiments of the first example method may further include determining if the current sample is safeguarded.

For some embodiments of the first example method, determining if the current sample is safeguarded includes determining if the first number is within the threshold parameter of a boundary of a neighboring quantization range.

Some embodiments of the first example method may further include performing an arithmetic decoding of the first value.

For some embodiments of the first example method, running the learning-based process includes passing at least one point of a point cloud through an artificial intelligence (AI) model.

For some embodiments of the first example method, determining the first number includes passing an output of the learning-based process through a bitstream matching process to generate the first number.

For some embodiments of the first example method, determining the first number includes passing a bitstream through a synthesis block to generate the first number.

For some embodiments of the first example method, determining the first number further includes passing an output of the synthesis block through a bitstream matching process to generate the first number.

For some embodiments of the first example method, passing the output of the synthesis block through the bitstream matching process includes using a probability bitstream (PBS) generated by an encoder.

For some embodiments of the first example method, the method is performed within an encoding process.

A first example apparatus in accordance with some embodiments may include: a processor; and a memory storing instructions operative, when executed by the processor, to cause the apparatus to: determine a first number by running a learning-based process, wherein the first number corresponds to a current sample associated with a point cloud; obtain a quantization parameter and a threshold parameter; obtain a safeguard bitstream; determine a rounded value of the first number; obtain a sample set, wherein the sample set indicates if the current sample is safeguarded; and output a number based on the rounded value if the current sample is safeguarded.

A second example method in accordance with some embodiments may include: performing a learning-based process to generate a first number, wherein the first number corresponds to a current sample associated with a point cloud; obtaining a quantization parameter and a threshold parameter; and responsive to determining that the first number is within the threshold parameter of a range, outputting a number based on a rounded value of the first number, wherein the range is determined using the quantization parameter.

Some embodiments of the second example method may further include determining the rounded value of the first number.

Some embodiments of the second example method may further include determining if the first number is within the threshold parameter of the range.

Some embodiments of the second example method may further include passing the number through an arithmetic decoder.

For some embodiments of the second example method, outputting the number is further responsive to determining that the current sample is safeguarded.

Some embodiments of the second example method may further include determining if the current sample is safeguarded.

For some embodiments of the second example method, determining if the current sample is safeguarded further includes: obtaining a safeguard bitstream; obtaining a sample set, wherein the sample set indicates if the current sample is safeguarded; and using at least one of the safeguard bitstream and the sample set to determine if the current sample is safeguarded.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: determining a first number by running a learning-based process, wherein the first number is associated with a current sample; obtaining a quantization parameter; determining a quantized value based on at least the quantization parameter for the first number; obtaining a sample set; responsive to determining that the current sample is not in the sample set, outputting the quantized value; and responsive to determining that the current sample is in the sample set, performing several steps including: determining a boundary value based on at least the quantization parameter and the first number; determining a second number based on the boundary value; and outputting the second number.

For some embodiments of the first example method, the sample is one of a group consisting of: a point in point cloud, a pixel in an image, and a pixel in a video.

For some embodiments of the first example method, obtaining a sample set includes: accessing a safeguard bitstream; and decoding the safeguard bitstream.

For some embodiments of the first example method, obtaining a sample set includes: decoding the flag associated with the current sample.

Some embodiments of the first example method further include determining if the current sample is not in the sample set.

For some embodiments of the first example method, determining if the current sample is not in the sample set includes determining if a flag is cleared, the flag is associated with the current sample, and the flag indicates membership in the sample set.

For some embodiments of the first example method, determining the first number includes: passing at least one data point through an artificial intelligence (AI) model, wherein the learning-based process is the AI model.

For some embodiments of the first example method, determining the first number includes passing a bitstream through a synthesis block to generate the first number.

For some embodiments of the first example method, determining the first number further includes passing an output of the synthesis block through a bitstream matching process to generate the first number.

For some embodiments of the first example method, passing the output of the synthesis block through the bitstream matching process includes using a probability bitstream (PBS) generated by an encoder.

For some embodiments of the first example method, the method is performed within an encoding process.

A first example apparatus in accordance with some embodiments may include: a processor; and a memory storing instructions operative, when executed by the processor, to cause the apparatus to: determine a first number by running a learning-based process, wherein the first number is associated with a sample; obtain a quantization parameter; determine a quantized value based on at least the quantization parameter for the first number; obtain a sample set; responsive to determining that the current sample is not in the sample set, output the quantized value; and responsive to determining that the current sample is in the sample set, perform several steps including: determine a boundary value based on at least the quantization parameter and the first number; determine a second number based on the boundary value; and output the second number.

A second example method in accordance with some embodiments may include: determining a first number by running a learning-based process, wherein the first number is associated with a current sample; obtaining a quantization parameter and a threshold parameter; determining a quantized value based on at least the quantization parameter for the first number; determining a boundary value based on the quantization parameter and the first number; responsive to determining that the first number is not within the threshold parameter from the boundary value, outputting the quantized value; and responsive to determining that the first number is within the threshold parameter from the boundary value, performing several steps including: setting a flag for the current sample; encoding the flag into a safeguard bitstream; determining a second number based on the boundary value; and outputting the second number.

For some embodiments of the second example method, the sample is one of a group consisting of: a point in point cloud, a pixel in an image, and a pixel in a video.

For some embodiments of the second example method, performing the several steps further includes adding the current sample to a sample set.

For some embodiments of the second example method, determining the first number includes: passing at least one data point through an artificial intelligence (AI) model, wherein the learning-based process is the AI model.

For some embodiments of the second example method, determining the first number includes passing a bitstream through a synthesis block to generate the first number.

For some embodiments of the second example method, determining the first number further includes passing an output of the synthesis block through a bitstream matching process to generate the first number.

For some embodiments of the second example method, passing the output of the synthesis block through the bitstream matching process includes using a probability bitstream (PBS) generated by an encoder.

For some embodiments of the second example method, the method is performed within a decoding process.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “l”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
determining a first number by running a learning-based process,
wherein the first number is associated with a current sample;
obtaining a quantization parameter;
determining a quantized value based on at least the quantization parameter for the first number;
obtaining a sample set;
responsive to determining that the current sample is not in the sample set, outputting the quantized value; and
responsive to determining that the current sample is in the sample set, performing several steps comprising:
determining a boundary value based on at least the quantization parameter and the first number;
determining a second number based on the boundary value; and
outputting the second number.

2. The method of claim 1, wherein the sample is one of a group consisting of: a point in point cloud, a pixel in an image, and a pixel in a video.

3. The method of claim 1, wherein obtaining a sample set comprises:
accessing a safeguard bitstream; and
decoding the safeguard bitstream.

4. The method of claim 1, wherein obtaining a sample set comprises:
decoding the flag associated with the current sample.

5. The method of claim 1, further comprising determining if the current sample is not in the sample set.

6. The method of claim 5,
wherein determining if the current sample is not in the sample set comprises determining if a flag is cleared,
wherein the flag is associated with the current sample, and
wherein the flag indicates membership in the sample set.

7. The method of claim 1, wherein determining the first number comprises:
passing at least one data point through an artificial intelligence (AI) model,
wherein the learning-based process is the AI model.

8. The method of claim 1, wherein determining the first number comprises passing a bitstream through a synthesis block to generate the first number.

9. The method of claim 8, wherein determining the first number further comprises passing an output of the synthesis block through a bitstream matching process to generate the first number.

10. The method of claim 9, wherein passing the output of the synthesis block through the bitstream matching process comprises using a probability bitstream (PBS) generated by an encoder.

11. The method of claim 1, wherein the method is performed within an encoding process.

12. An apparatus comprising:
a processor; and
a memory storing instructions operative, when executed by the processor, to cause the apparatus to:
determine a first number by running a learning-based process,
wherein the first number is associated with a sample;
obtain a quantization parameter;
determine a quantized value based on at least the quantization parameter for the first number;
obtain a sample set;
responsive to determining that the current sample is not in the sample set, output the quantized value; and
responsive to determining that the current sample is in the sample set, perform several steps comprising:
determine a boundary value based on at least the quantization parameter and the first number;
determine a second number based on the boundary value; and
output the second number.

13. A method comprising:
determining a first number by running a learning-based process,
wherein the first number is associated with a current sample;
obtaining a quantization parameter and a threshold parameter;
determining a quantized value based on at least the quantization parameter for the first number;
determining a boundary value based on the quantization parameter and the first number;
responsive to determining that the first number is not within the threshold parameter from the boundary value, outputting the quantized value; and
responsive to determining that the first number is within the threshold parameter from the boundary value, performing several steps comprising:
setting a flag for the current sample;
encoding the flag into a safeguard bitstream;
determining a second number based on the boundary value; and
outputting the second number.

14. The method of claim 13, wherein the sample is one of a group consisting of: a point in point cloud, a pixel in an image, and a pixel in a video.

15. The method of claim 13, wherein performing the several steps further comprises adding the current sample to a sample set.

16. The method of claim 13, wherein determining the first number comprises:
passing at least one data point through an artificial intelligence (AI) model,
wherein the learning-based process is the AI model.

17. The method of claim 13, wherein determining the first number comprises passing a bitstream through a synthesis block to generate the first number.

18. The method of claim 17, wherein determining the first number further comprises passing an output of the synthesis block through a bitstream matching process to generate the first number.

19. The method of claim 18, wherein passing the output of the synthesis block through the bitstream matching process comprises using a probability bitstream (PBS) generated by an encoder.

20. The method of claim 13, wherein the method is performed within a decoding process.
